(19) United States
(12) Patent Application Publication
(10) Pub. No.: US 2025/0223664 A1
(43) Pub. Date: Jul. 10, 2025

(54) Grain-Oriented Flat Steel Product and Method for Its Production

(71) Applicant: ThyssenKrupp Electrical Steel GmbH, Gelsenkirchen (DE)

(72) Inventors: Christian Hecht, Mülheim an der Ruhr (DE); Andreas Jansen, Dinslaken (DE); Paul Betken, Bochum (DE); Chaoyong Wang, Dortmund (DE)

(21) Appl. No.: 19/095,968

(22) Filed: Mar. 31, 2025

(30) Foreign Application Priority Data
Dec. 12, 2024 (CA) 3259291
Dec. 12, 2024 (EP) 24219363.9
Dec. 12, 2024 (IN) 202414098331

(51) Int. Cl. C21D 9/46; C21D 1/30; C21D 6/00; C21D 8/12; C21D 10/00; C22C 38/00; C22C 38/02; C22C 38/04; C22C 38/06; C22C 38/16; C23C 8/26; H01F 1/147

(52) U.S. Cl. CPC C21D 9/46; C21D 1/30; C21D 6/005; C21D 6/008; C21D 8/1233; C21D 8/1255; C21D 8/1283; C21D 10/005; C22C 38/001; C22C 38/002; C22C 38/02; C22C 38/04; C22C 38/06; C22C 38/16; C23C 8/26; H01F 1/14783; H01F 1/14791; C21D 2201/05; C22C 2202/02

(57) ABSTRACT

A method for producing a grain-oriented flat steel product including: providing a cold-rolled flat steel product; primary recrystallization annealing the cold-rolled flat steel product with simultaneous decarburization; coating the annealed flat steel product with a slurry; reeling the coated flat steel product to form a coil; bell annealing the coil at a soaking temperature of at least 1100° C.; applying an insulation coating to the annealed flat steel product; stress relieving the coated flat steel product forming an insulation layer; carrying out domain refinement using a laser having a wavelength WL on at least one side of the flat steel product provided with the insulation layer, wherein

$$573 + \frac{( 60 \times dp 1 + 10 \times dp 2 )}{w 1} < WL < 1080 + \frac{18 \times dp 1 + 3 \times dp 2}{w 1}$$

where w1 is the mass ratio of water to total solids in the slurry, dp1 is the dew point measured at 400° C. and dp2 is the dew point measured at 800° C. between the turns of the coil during heating to soaking the temperature.

### CROSS-REFERENCE TO RELATED APPLICATIONS

This application claims priority to European Patent Application No. 24219363.9, filed Dec. 12, 2024, Canadian Patent Application No. 3,259,291 filed Dec. 12, 2024, and Indian Patent Application No. 202414098331 filed Dec. 12, 2024, the disclosures of which are hereby incorporated by reference in their entireties.

### BACKGROUND OF THE INVENTION

### Field of the Invention

The invention relates to a grain-oriented flat steel product with minimized magnetic loss values and optimized magnetostrictive properties and a method for its production.

### Description of Related Art

The grain-oriented flat steel products in question here, also known in technical terms as “HGO material,” are steel strips, also known in technical terms as “electrical steel strips,” or steel sheets, also known in technical terms as “electrical steel sheets.” Such flat steel products are used to manufacture parts for electrical engineering applications.

Grain-oriented electrical steel strip or sheet is suitable, in particular, for uses in which the priority is a particularly low core loss, and high demands are made on the permeability or polarization. Such requirements exist in particular in the case of parts for power transformers, distribution transformers and high-quality small transformers.

As explained in detail for example in EP 1 025 268 B1, in the course of the production of flat steel products, in general first a steel which (in wt. %) typically comprises 2.5 to 4.0% Si, 0.010 to 0.100% C, up to 0.150% Mn, up to 0.065% Al and up to 0.0150% N, and in each case optionally 0.010 to 0.3% Cu, up to 0.060% S, up to 0.100% P, up to 0.2% As, Sn, Sb, Te and Bi, remainder iron and unavoidable impurities, is cast into a preliminary material, such as a slab, thin slab or a cast strip. If necessary, the preliminary material is then subjected to an annealing treatment and subsequently hot rolled to form a hot strip.

After reeling and an optional additional annealing as well as an optional descaling or pickling treatment, the hot strip is then rolled into a cold strip in one or more steps, whereby intermediate annealing can be carried out between the cold rolling steps if necessary. During the subsequent decarburization annealing, the carbon content of the cold strip is usually significantly reduced in order to avoid magnetic ageing.

After the decarburization annealing, an annealing separator, which is typically MgO, is applied to the strip surfaces. The annealing separator prevents the windings of a coil wound from the cold strip from welding together in the case of subsequently carried out high-temperature annealing. During the high-temperature annealing, which is typically carried out in a bell furnace under protective gas, the texture is produced in the cold strip by selective grain growth. Furthermore, a forsterite layer, the so-called “glass film,” forms on the strip surfaces. In addition, the steel material is purified by diffusion processes occurring during high-temperature annealing.

Following the high-temperature annealing, the flat steel product obtained in this way is coated with an insulation layer and annealed in a thermally directed and stress-relieved manner in a concluding “final annealing.” This final annealing can be carried out before or after the flat steel product produced in the manner described above has been cut into the blanks required for further processing, whereby the additional stresses created during the cutting process can be reduced by a final annealing after the blanks have been cut. Flat steel products produced in this way generally have a thickness of 0.15 mm to 0.5 mm.

The metallurgical properties of the material, the degrees of deformation of the cold rolling processes used to produce the flat steel products and the parameters of the heat treatment steps are each coordinated in such a way that targeted recrystallization processes take place. These recrystallization processes lead to the “Goss texture” typical for the material, in which the direction of easiest magnetization lies in the rolling direction of the finished strip. Grain-oriented flat steel products therefore exhibit strongly anisotropic magnetic behavior.

There are various methods to improve the core losses of a grain-oriented flat steel product. For example, the orientation sharpness of the Goss texture of the flat steel product can be improved. Further loss reductions can be achieved by reducing the distances between the 180° domain walls. High tensile stresses in the rolling direction, which are transferred to the steel surface via insulation coatings, also contribute to the reduction of the domain spacing and thus to the reduction of the core losses. However, for technical reasons, the required tensile stress values can only be achieved to a limited extent.

A further possibility for loss improvement, proposed for example in DE 18 04 208 B1 or EP 0 409 389 A2, is to produce partial plastic deformations on the surface of the flat steel product. This can be done, for example, by mechanically scratching or piercing the surfaces of the relevant flat steel product. The significant improvements in the magnetic properties achieved in this way are offset by the disadvantage that the mechanical processing of the surface damages the insulation layer applied to the flat steel product. For example, in the case of the production of transformer sheets from such a flat steel product, this can lead to short circuits in the stacked core of the transformer as well as to local corrosion.

Attempts to exploit the advantages of mechanical scoring or piercing without destroying the insulation have focused on the use of laser sources (EP 0 008 385 B1, EP 0 100 638 B1, EP 1 607 487 A1). What the methods based on the use of lasers have in common is that a laser beam is focused on the surface of the flat steel product to be treated and thermal stress is generated in the base material. This leads to the formation of dislocations where components of the magnetic flux escape from the surface of the flat steel product. This locally increases the magnetic stray field energy, which is compensated for by the formation of so-called “termination domains,” which are also referred to as “secondary structures” in technical terms. At the same time, a reduction in the main domain distance occurs.

Since the abnormal core loss depends on the distance between the main domains, the losses are minimized by appropriate laser treatment. Through laser treatment, the core loss of a grain-oriented flat steel product with a nominal thickness of 0.23 mm, which is typical for these products, can be improved by more than 10% compared to the untreated state. The loss improvements depend on the properties of the base material, such as grain size and texture sharpness, as well as on the laser parameters, which include the distance L of the lines along which the laser beams are guided onto the relevant flat steel product, the exposure time t_{dwell} and the specific energy density Us. The adjustment of these parameters has a decisive influence on the reduction in core losses achieved.

In addition to the core losses, noise generation also plays a role in transformers. This is based on a physical effect known as magnetostriction.

Magnetostriction is the change in length of a ferromagnetic material in the direction of its magnetization. By operating a ferromagnetic component such as a transformer in an alternating magnetic field, the 180° main domains are shifted, which alone does not contribute to magnetostriction. However, magnetostrictive stresses exist in the material at transitions between the 180° main domains and the 90° terminal domains. These form a sound source when operating in an alternating magnetic field and are the cause of transformer noise.

The introduction of additional 90° termination domains, i.e. secondary structures, by laser treatment generally leads to an increase in magnetostriction and thus in noise emissions, in particular during operation of a transformer.

The requirements for minimizing noise generation during operation of transformers are constantly increasing. On the one hand, this is due to continuously tightened legal specifications and standards. On the other hand, consumers today generally no longer accept electrical devices that produce an audible “transformer hum.” Today, the acceptance of large transformers near residential areas depends crucially on the noise emissions that result from the operation of such transformers.

A number of laser treatment processes have been proposed which can achieve both loss improvements and better magnetostrictive properties by choosing appropriate process parameters (DE 601 12 357 T2/EP 1 154 025 B1, DE 698 35 923 T2/EP 0 897 016 B1, EP 2 006 397 A1, EP 1 607 487 A1). However, the optimization of the laser treatment parameters was only carried out with a view to improving the core losses.

EP 4 261 853 A1 describes a method for producing a grain-oriented steel strip with low magnetostriction. The method provides that first, using a formula, the difference in the curvature of one side and the other side of the steel strip is approximately determined as a function of the laser etching power and, based on this difference, the application quantities of the relevant insulation layer for one side and the other are determined and then applied. The difference in curvature between one side and the other side of the steel strip caused by the one-sided laser etching is reduced by adjusting a voltage difference between the insulation layer on one side and the other side of the steel strip by means of different application quantities of the insulation layer on the two sides, which also reduces the magnetostrictive deviation between the two sides. As a result, a thicker insulation layer is applied to the side not treated by laser etching than to the side treated with the laser.

A disadvantage of the procedure described in EP 4 261 853 A1 is that the formula for the approximate calculation of the curvature used therein ignores the fact that the forsterite layers also exert tensile stresses on the flat steel product, which lead to curvatures and thus influence the overall curvature. In addition, determining the curvature of the steel strip to determine the application quantities for the relevant insulation layer is industrially complex and cannot be easily integrated into a continuous manufacturing process. In particular, the inventors of EP 4 261 853 A1 did not recognize that the transmittance of the forsterite layer for the laser wavelength plays a role in simultaneously achieving a desired magnetostriction and improving the core loss of a grain-oriented flat steel product.

Furthermore, this manufacturing process has the disadvantage that the grain-oriented flat steel product has a lower insulating effect on the side treated by laser etching. This is due to the manufacturing process, which involves laser etching after the insulating layer has been applied. As a result, the insulating layer on the steel substrate is at least partially removed. This results in a defective local insulation effect and has the disadvantage for the manufacturer of an electrical machine or transformer that he must take great care not to place the laser-treated sides of the sheets on top of each other in order to avoid a short circuit.

In addition, the removal of the insulation layer on the steel substrate has the disadvantage that the resulting grain-oriented flat steel product has a different surface roughness than conventional grain-oriented flat steel products. When these grain-oriented flat steel products are used to manufacture machines or transformers, the different roughness, especially when the grain-oriented flat steel products are being laid automatically, means that the slip behavior is different from that of conventional grain-oriented flat steel products. This different sliding behavior means, among other things, that the manufacturer has to work with a single type of material and is not allowed to mix grain-oriented flat steel products from different manufacturers, as is usually the case.

### SUMMARY OF THE INVENTION

Against the background of the prior art explained above, the object of the invention was to provide a method for producing a grain-oriented flat steel product which has optimized magnetostrictive properties while at the same time minimizing core losses and is optimally suited for the production of parts for transformers, without significantly impairing the insulating effect of the grain-oriented flat steel product.

Advantageous embodiments of the invention are explained in detail below, as is the general inventive concept.

In accordance with the prior art explained above, a method according to the invention for producing a grain-oriented flat steel product comprises the work steps
a) providing a cold-rolled flat steel product having the following composition, in wt. %:
   Si: 2.0-4.0%,
   C: 0.01-0.10%,
   Alₛᵢ: 0.01-0.065%,
   N: 0.003-0.015,
   optionally one or more elements selected from the group consisting of Se, Sn, Sb, the individual contents of these elements being up to 0.2%,
   optionally one or more elements selected from the group consisting of Cr, Cu, Mn, the individual contents of these elements being up to 0.60%,
   optionally one or more elements selected from the group consisting of As, Bi, B, Co, P, S, Te, Ti, V, Ni, Nb, Mo, the individual contents of these elements being up to 0.05%, remainder iron and unavoidable impurities;
b) primary recrystallization annealing the cold-rolled flat steel product with simultaneous decarburization treatment in a humid atmosphere to a carbon content of less than 30 ppm;
c) optionally carrying out a nitriding treatment during step b) or subsequently in step c);
d) coating the flat steel product obtained in step b) or in the optional step c) with a slurry, wherein the slurry consists of water, MgO and optionally one or more further solid(s) and has a mass ratio w1 of water to total solid(s) in the slurry;
e) reeling the coated flat steel product to form a coil;
f) bell annealing the coil at a soaking temperature of at least 1100° C. with a dew point dp 1 measured between the turns of the coil at 400° C. during heating to soaking temperature and a dew point dp 2 measured between the turns of the coil at 800° C. during heating to soaking temperature,
g) applying an insulation coating to the annealed flat steel product,
h) stress relieving the flat steel product provided with the insulation coating forming an insulation layer,
i) carrying out domain refinement by means of a laser having a wavelength WL on at least one side of the flat steel product provided with the insulation layer, wherein the wavelength WL of the laser satisfies the specification of the following formula (I):

$$537 + \frac{( 60 \times dp 1 + 10 \times dp 2 )}{w 1} < WL < 1080 + \frac{18 \times dp 1 + 3 \times dp 2}{w 1} . \qquad ( I )$$

A further subject matter of the invention is a grain-oriented flat steel product, comprising a steel core having the following composition, in wt. %:
Si: 2.0-4.0%,
C: <30 ppm,
Alₛᵢ: <30 ppm,
N: <50 ppm,
optionally one or more elements selected from the group consisting of Se, Sn, Sb, the individual contents of these elements being up to 0.2%,
optionally one or more elements selected from the group consisting of Cr, Cu, Mn, the individual contents of these elements being up to 0.60%,
optionally one or more elements selected from the group consisting of As, Bi, B, Co, Te, Ti, V, Ni, Nb, Mo, the individual contents of these elements being up to 0.05%,
optionally
S: <50 ppm
P 0.0003% to 0.05%
   remainder iron and unavoidable impurities,
   and a forsterite layer on at least one side of the steel core in full-surface contact therewith, wherein the side of the forsterite layer facing away from the steel core is in full-surface contact with an insulation layer, wherein at least one side of the grain-oriented flat steel product has been treated with a laser for domain refinement, characterized in that the difference in magnetostriction, measured according to IEC 60404-17 (2021) with a mirror, between one side of the grain-oriented flat steel product and the other side of the grain-oriented flat steel product is less than 1 dB(A), and wherein the grain-oriented steel flat product has a core loss, measured according to IEC 60404-3 (2022) at 50 Hz and 1.7 T and a conversion factor of 0.925 according to IEC 60404-8-7 (2020), of at most 0.75 W/kg.

### BRIEF DESCRIPTION OF THE DRAWING

The invention is explained in more detail with reference to the following figure. The terms Fig., Figs., Figure, and Figures are used interchangeably in the specification to refer to the corresponding figures in the drawings.

FIG. 1: Cross section of a coil with built-in measuring instruments for measuring temperature and dew points.

### DESCRIPTION OF THE INVENTION

A method according to the invention for producing a grain-oriented flat steel product comprises the work steps:
a) providing a cold-rolled flat steel product having the following composition, in wt. %:
   Si: 2.0-4.0%,
   C: 0.01-0.10%,
   Alₛᵢ: 0.01-0.065%,
   N: 0.003-0.015,
   optionally one or more elements selected from the group consisting of Se, Sn, Sb, the individual contents of these elements being up to 0.2%,
   optionally one or more elements selected from the group consisting of Cr, Cu, Mn, the individual contents of these elements being up to 0.60%,
   optionally one or more elements selected from the group consisting of As, Bi, B, Co, P, S, Te, Ti, V, Ni, Nb, Mo, the individual contents of these elements being up to 0.05%, remainder iron and unavoidable impurities;
b) primary recrystallization annealing the cold-rolled flat steel product with simultaneous decarburization treatment in a humid atmosphere to a carbon content of less than 30 ppm;
c) optionally carrying out a nitriding treatment during step b) or subsequently in step c);
d) coating the flat steel product obtained in step b) or in the optional step c) with a slurry, wherein the slurry consists of water, MgO and optionally one or more further solid(s) and has a mass ratio w1 of water to total solid(s) in the slurry;
e) reeling the coated flat steel product to form a coil;
f) bell annealing the coil at a soaking temperature of at least 1100° C. with a dew point dp 1 measured between the turns of the coil at 400° C. during heating to soaking temperature and a dew point dp 2 measured between the turns of the coil at 800° C. during heating to soaking temperature,
g) applying an insulation coating to the annealed flat steel product,
h) stress relieving the flat steel product provided with the insulation coating forming an insulation layer,
i) carrying out domain refinement by means of a laser having a wavelength WL on at least one side of the flat steel product provided with the insulation layer, wherein the wavelength WL of the laser satisfies the specification of the following formula (I):

$$537 + \frac{( 60 \times dp 1 + 10 \times dp 2 )}{w 1} < WL < 1080 + \frac{18 \times dp 1 + 3 \times dp 2}{w 1} . \qquad ( I )$$

The method according to the invention may comprise further steps which are known to a person skilled in the art and which are usually carried out in the production of grain-oriented flat steel products.

The invention is based on the finding that optimized magnetostrictive properties with simultaneously minimized core losses of a grain-oriented electrical steel strip according to the invention can be ensured by carefully controlling the conditions in method steps d), f) and i). In particular, minimized core losses of less than 0.75 W/kg determined according to IEC 60404-3 (2022) at 50 Hz and 1.7 T with a conversion factor of 0.925 according to IEC 60404-8-7 (2020) can be obtained.

It was found that the level of laser energy input during the domain refinement carried out in accordance with step i) is influenced by the transmittance of the forsterite layer for the laser wavelength selected for domain refinement. It was found that the transmittance of the forsterite layer can be controlled by adjusting the dew point during the bell annealing in step f). The dew point in step f) is further influenced by the water content in the slurry applied in accordance with step d).

The higher the transmittance of the forsterite layer for the laser wavelength selected for domain refinement in step i), the lower the energy loss of the laser in the forsterite layer. In conjunction with this, the domain refinement through the thermal shock of the laser takes place in deeper, less surface-near regions of the grain-oriented flat steel product at the higher transmittance of the forsterite layer set by the method according to the invention.

In order to achieve a transmittance of the forsterite layer for the selected laser wavelength that is sufficient for the purposes of the invention, the condition of formula (I) must be met in the method according to the invention.

The inventors have recognized that this can, on the one hand, reduce the core losses of the grain-oriented flat steel product, while, on the other hand, there is a significantly smaller increase in magnetostriction due to domain refinement.

By combining the measures according to the invention in the production of the grain-oriented flat steel product, in particular in steps d), f) and i) of the method according to the invention and meeting the condition in accordance with formula (I), reliably improved core losses of the grain-oriented electrical steel strip can be achieved with simultaneously optimized magnetostrictive properties.

There are no special requirements regarding the manner of manufacturing the cold-rolled flat steel product provided in accordance with work step a). Thus, the cold-rolled flat steel product provided for the method according to the invention can be produced using the measures generally known to a person skilled in the art and summarized at the outset which are also already sufficiently known from the prior art. This of course also includes manufacturing processes that are currently unknown. The cold-rolled flat steel product can be produced in particular by casting a steel with an appropriate alloy to form a starting material, such as a slab, thin slab or cast strip, which is subjected to an annealing treatment and then hot-rolled to form a hot strip. The hot strip can be reeled in the usual way and optionally annealed and subjected to descaling or pickling treatment. Subsequently, a cold-rolled flat steel product can be produced from the hot strip in one or more steps by cold rolling, wherein intermediate annealing can be carried out between the cold rolling steps if necessary. Methods for cold rolling a grain-oriented steel strip are generally known to a person skilled in the art and are described, for example, in WO 2007/014868 A1 and WO 99/19521 A1. Typically, an intermediate annealing is carried out in a temperature range of 700 to 1150° C., preferably 800 to 1100° C., under an atmosphere, the dew point of which is set at 10 to 80° C. Typical annealing times are 30 s to 900 s. Systems with which such intermediate annealing can be carried out are generally known and are described, for example, in WO 2007/014868 A1 and WO 99/19521 A1. The thickness of the cold-rolled flat steel product is typically 0.15 to 0.5 mm, particularly preferred is a maximum thickness of 0.35 mm, preferably of at most 0.27 mm or of at most 0.23 mm.

The cold-rolled flat steel product provided in step a) by the method according to the invention contains 2.0 to 4.0 wt. % silicon (Si). A silicon content of 2.5 to 3.5 wt. % has proven to be particularly advantageous with regard to the magnetic properties of a grain-oriented flat steel product according to the invention. Si is needed to improve the permeability of the grain-oriented flat steel product. A Si content below 2.0 wt. % is not sufficient to achieve high permeability and thus low core loss. In addition, a Si content below 2.0 wt. % is detrimental to the formation of a forsterite layer, since at such low silicon contents too little fayalite (FeSiO₄), from which the forsterite layer is formed during the bell annealing process, is created. If the Si content exceeds 4.0 wt. %, the processability of the flat steel product deteriorates, i.e., the flat steel product becomes more brittle and has an increased tendency to crack during processing, such as cold rolling. In addition, the microstructural transformation from ferrite to austenite (alpha/gamma transformation) is suppressed.

The amount of carbon (C) in the cold-rolled flat steel product provided in step a) according to the method of the invention is 0.01 to 0.10 wt. %, particularly preferably 0.03 to 0.08 wt. %. C is used to improve the hot-rolled structure of the steel by promoting the formation of austenite. In addition, C is required during cold rolling to inhibit dislocation movements and thus promote recrystallization. Therefore, the C content should be at least 0.01 wt. %. However, C contents above 0.10 wt. %, which is too high, lead to problems during decarburization annealing, and remaining C in the finished grain-oriented flat steel product leads to increased core loss and should therefore preferably be avoided.

The cold-rolled flat steel product provided in step a) by the method according to the invention contains 0.01 to 0.065 wt. % of acid-soluble aluminum (Alₛᵢ). An aluminum content of 0.015 to 0.050 wt. % has proven to be particularly advantageous with regard to an optimal content and grain size of inhibitor particles which inhibit grain growth and lead to a favorable grain orientation of the finished grain-oriented flat steel products. Aluminum contents below 0.01 wt. % lead to few inhibitor particles and thus to a weak inhibition of grain growth during bell annealing. An aluminum content of more than 0.065 wt. % leads to coarse inhibitor particles, which also exhibit weak inhibition.

Nitrogen (N) is contained in the cold-rolled steel provided in step a) of the method according to the invention in an amount of 0.003 to 0.015 wt. %, in particular 0.0035 to 0.013 wt. % N. N is required as an inhibitor-forming element, which together with Al leads to the formation of AlN. If the N content is below 0.003 wt. %, the inhibition is insufficient. Higher N contents than 0.015 wt. % lead to problems during rolling and poor surface quality.

The cold-rolled flat steel product provided in step a) optionally contains one or more elements selected from the group consisting of Se, Sn, Sb, the individual contents of these elements being up to 0.2 wt. %. It has proven to be particularly practical if the individual contents of the aforementioned elements are at least 0.002 wt. %.

Tin (Sn) improves the magnetic quality by stabilizing the formation of oxide layers and forsterite film (glass film) and can be present in the steel composition at a minimum of 0.002 wt. %. A Sn content of more than 0.2 wt. % reduces oxidation and prevents the formation of a stable forsterite film (glass film).

Antimony (Sb) may optionally be included in the cold-rolled flat steel product to act as a segregation element to disrupt grain boundary movements. It inhibits grain growth and thus influences the recrystallization towards the formation of a desired final Goss texture in the finished grain-oriented flat steel product. The above-mentioned positive effects are sure to occur at a concentration of 0.002 wt. % or more. If the Sb content is increased to more than 0.2 wt. %, the processability deteriorates and the probability of strip breaks during rolling increases. Furthermore, the oxidation-inhibiting effect of antimony leads to the formation of an uneven forsterite film. This has a negative effect on the magnetic properties of the grain-oriented flat steel product.

Selenium (Se) together with Mn forms MnSe, which acts as an inhibitor for recrystallization and supports the formation of the desired Goss texture. This improves the core loss of the grain-oriented flat steel product. A Se content below 0.002 wt. % does not have a positive effect on the formation of MnSe particles. A content of more than 0.2 wt. % Se, which is too high, leads to coarse particles, the inhibiting effect of which is not sufficient to effectively hinder recrystallization.

Furthermore, the flat steel product provided in step a) may optionally contain one or more elements selected from the group consisting of Cr, Cu, Mn, wherein the individual contents of these elements are up to 0.60 wt. %. Preferably, the individual contents of these elements are at least 0.002 wt. %.

The cold-rolled steel provided in step a) of the method according to the invention preferably contains 0.002 to 0.60 wt. % manganese (Mn). A manganese content of 0.05 to 0.3 wt. %, preferably 0.05 to 0.25 wt. %, has proven to be particularly advantageous. The addition of at least 0.01 wt. % Mn reduces the core loss by increasing the specific resistance of the grain-oriented flat steel products and improves the hot formability of the flat steel product. A Mn content above 0.5 wt. % reduces the magneticflux density of grain-oriented flat steel products and should therefore preferably be avoided.

Cr, like Sn, improves the magnetic quality by additionally stabilizing the formation of the oxide layers and the forsterite layer (glass film). These positive effects are sure to occur at a Cr content of 0.002 wt. % or higher. A Cr content of more than 0.60 wt. % reduces the degree of oxidation so that a stable forsterite layer cannot form.

Cu reduces the degree of oxidation and stabilizes secondary recrystallization during bell annealing. In addition, Cu forms CuS precipitates, which act as grain growth inhibitors during bell annealing and thus promote favorable secondary recrystallization. In order to effectively improve the magnetic quality, the Cu content should be at least 0.002 wt. %, while a Cu content exceeding 0.60 wt. % will affect the hot rollability due to the formation of hard particles.

Finally, the flat steel product provided in step a) may optionally contain one or more elements selected from the group consisting of As, Bi, B, Co, P, S, Te, Ti, V, Ni, Nb, Mo, wherein the individual contents of these elements are up to 0.05 wt. %. The individual contents of these elements are preferably at least 0.0003 wt. %.

Sulfur (S) is required as a component of the inhibitors MnS and CuS, which support stable secondary recrystallization with preferential orientation of the crystal grains in the {110}<001> direction. This supportive effect becomes noticeable at a S content of at least 0.0003 wt. % or more. Sulfur contents above 0.05 wt. %, in turn, result in purification during the bell annealing process taking too long or not being able to take place sufficiently, so that S-containing inhibitor particles remain, which have a negative effect on the magnetic properties of the grain-oriented flat steel product.

Titanium (Ti) reacts with nitrogen to form TiN particles. Due to the stability of the particles at high temperatures, TiN acts primarily as an inhibitor for secondary recrystallization during bell annealing. A content below 0.0003 wt. %, which is too low, does not lead to the desired inhibition support. A Ti content above 0.05 wt. % would in turn result in purification during the bell annealing taking too long, being uneconomical and/or too many particles remaining after the bell annealing, which in turn would worsen the core losses.

Molybdenum (Mo) suppresses high-temperature corrosion by forming a thin layer of MoSi₂ on the surface of the steel strip. This advantageous effect is certain to occur at a Mo content of 0.0003 wt. %. However, if the Mo content exceeds 0.05 wt. %, no further improvement of the above-mentioned effect occurs.

Phosphorus (P) increases the specific resistance of the grain-oriented flat steel product and thus reduces the core loss. In practice, this effect can be reliably achieved at a content of 0.0003 wt. % or more. A P content above 0.05 wt. % leads to poor cold rollability.

Bismuth (Bi) stabilizes precipitates such as MnS or CuS and thus supports the inhibition effect. This positive effect only occurs reliably at a concentration of 0.0003 wt. % or more. A Bi content above 0.05 wt. % impairs the formation of a forsterite film (glass film) and thus the magnetic properties of the finished grain-oriented flat steel product.

Ni, Co, As, B, Te, V, and Nb support the inhibition effect during secondary recrystallization and thus have a positive influence on the core loss. This effect is definitely achieved at a relevant concentration of 0.0003 wt. % or more. Excessive contents of these elements of more than 0.05 wt. % each lead to purification problems during bell annealing and sometimes to difficulties in cold rolling.

In accordance with a preferred embodiment of the method according to the invention, in step a) a cold-rolled flat steel product is provided which has, in wt. %, the following composition:
Si: 2.0-4.0%,
C: 0.01-0.10%,
Alₛᵢ: 0.01-0.065%,
N: 0.003-0.015%,
Mn: 0.002 to 0.60%,
Cu: 0.002 to 0.60%,
P: 0.0003 to 0.05%,
optionally one or more elements selected from the group consisting of Se, Sn, Sb, the individual contents of these elements being up to 0.2%,
optionally up to 0.60% Cr,
optionally one or more elements selected from the group consisting of As, Bi, B, Co, S, Te, Ti, V, Ni, Nb, Mo, the individual contents of these elements being up to 0.05%, remainder iron and unavoidable impurities.

Preferably, the cold-rolled flat steel product provided in step a) of the method according to the invention contains a maximum of 0.5 wt. %, in particular a maximum of 0.3 wt. %, of unavoidable impurities.

In work step b) of the method according to the invention, primary recrystallization annealing with simultaneous decarburization treatment (also referred to jointly as “decarburization annealing”) of the cold-rolled flat steel product provided in step a) is carried out in a humid atmosphere to a carbon content, determined according to ASTM E 1019:2018, of less than 30 ppm. The decarburization annealing is preferably carried out at temperatures in the range of 600 to 950° C., particularly preferably 600 to 900° C. Temperatures in the range of 600 to 950° C. are required to form the desired oxides, in particular fayalite and silicon dioxide, which are necessary for the formation of the forsterite layer in step f). In this context, it has proven to be particularly practical if the temperature during decarburization annealing is at least 820° C. The duration of the decarburization annealing is preferably 30 to 300 s, preferably 70 to 200 s. If the duration is too short, less than 30 s, sufficient oxide formation cannot be ensured. Durations of more than 300 s result in the resulting oxide layer becoming too thick and all surface-controlled chemical reactions, e.g., decarburization, nitriding, denitriding, no longer being able to take place in a controlled manner. Decarburization annealing is usually carried out in a high dew point atmosphere (“humid atmosphere”) at a dew point between 4° and 80° C., preferably between 4° and 65° C. A dew point of more than 80° C. leads to a high proportion of oxidized iron, which has a negative effect on the reactivity of the oxide layer, while at a dew point below 40° C. the resulting oxide layer becomes too dense, so that all surface-controlled chemical reactions, e.g., decarburization, nitriding, denitriding, can no longer take place in a controlled manner. The atmosphere may consist of 5 to 95 vol. % H₂, the remainder being nitrogen or any inert gas or a mixture of nitrogen and one or more inert gases.

The method according to the invention optionally provides for carrying out a nitriding treatment during the primary recrystallization annealing with simultaneous decarburization treatment in step b) or subsequently in step c). If a nitriding treatment is to be carried out during the decarburization annealing in step b), the decarburization annealing can be carried out under an atmosphere containing N₂ or N-containing compounds, for example NH₃. Alternatively, decarburization annealing and nitriding can be carried out in two separate steps one after the other, with decarburization annealing being carried out first. Preferably, a nitriding level of at least 150 ppm is set. A nitriding level below 150 ppm, which is too low, leads to a weak inhibition system and impairs the secondary recrystallization, which is crucial for the magnetic properties of the finished grain-oriented electrical steel sheet. If nitriding is carried out following decarburization annealing in step c) of the method according to the invention, the conditions of the nitriding treatment should also be adjusted so that a nitriding level of at least 150 ppm is achieved. Typically, an annealing temperature between 70° and 900° C. is set and a dew point below 40° C. is selected. The annealing time is usually between 10 and 200 s. The N, N₂ or NH₃ content are selected so that the desired nitriding level is ensured. This also applies to a nitriding treatment carried out simultaneously with the decarburization annealing in step b). The nitriding level is calculated from the difference between the nitrogen content of the steel strip before stress relieving (step h) minus the nitrogen content before decarburization annealing (step b). The nitrogen content can be determined in a conventional manner, e.g., with an Analyzer 736 offered by Leco Corporation, St. Joseph, USA.

In step d) of the method according to the invention, the flat steel product obtained in step b) or in the optional step c) is coated with a slurry, wherein the slurry consists of water, MgO and optionally one or more further solid(s) and has a mass ratio w1 of water to total solid(s) in the slurry. Preferably, a mass ratio w1 to the total solid(s) in the slurry is 5 to 11. A mass ratio w1 of water to total solid(s) in the slurry of less than 5 results in uneven application of the slurry and increases the risk of clogged equipment required for slurry application. A mass ratio w1 of water to the total solid(s) in the slurry of more than 11 leads to long drying times of the slurry and to excessively high dew points in the bell annealing in step f). Excessively high dew points are detrimental because they lead to oxides with a high degree of oxidation, such as MgSiO₃, which in turn prevent uniform forsterite film formation (glass film formation). In the sense of the invention, MgO is considered to be part of the solids of the slurry. When the total solid(s) content of the slurry is referred to in the following, this is understood to mean the total solids content of the slurry including MgO. In accordance with a preferred embodiment of the method according to the invention, further solids in addition to MgO in the slurry may be selected from oxides and/or nitrides of at least one element selected from Al, Cr, Fe, Mn, Si, Ti, Mg, Sn, Cu, Zn, Zr and mixed oxides of said oxides with Mg. MgO and the optionally present other solids in the slurry act as nucleation sites to facilitate the phase transition from fayalite to forsterite in step f) of the method according to the invention. The slurry may comprise, based on the total solids content of the slurry, at least 70 wt. % MgO, optionally up to 25 wt. % oxides and/or nitrides of at least one element selected from Al, Cr, Fe, Mn, Si, Ti, Mg, Sn, Cu, Sn, Zr and mixed oxides of said oxides with Mg, and may further contain up to 5 wt. % additives, based on the total solids content of the slurry. These additives may be, for example, elements such as Ca, B and Sr, ammonium chloride or antimony chloride and other salts such as magnesium sulfate or sodium chloride, the addition of which controls the density of the forsterite layer formed after the bell annealing in step f) and the gas exchange between the annealing atmosphere and the metal during the bell annealing in step f).

In step e) of the method according to the invention, the flat steel product coated in step d) is reeled into a coil. The reel tension is preferably between 30 and 300 MPa. A reel tension of less than 30 MPa would lead to a collapse of the coil due to excessive free volumes between the turns and the dew point during the bell annealing would be significantly lowered since the total water content of the slurry would immediately diffuse out of the turns of the coil. At a reel tension of more than 300 MPa, the dew point would be significantly increased during the bell annealing because the humidity from the water content of the slurry cannot diffuse out of the coil turns.

The coil obtained in step e) is annealed in step f) in a bell furnace at a soaking temperature of at least 1100° C. with a dew point dp 1 measured between the turns of the coil at 400° C. during heating to soaking temperature and a dew point dp 2 measured between the turns of the coil at 800° C. during heating to soaking temperature.

The dew point dp 1 at 400° C. is an indicator for the basic oxidation of the surface by water of crystallization. The dew point dp 2 at 800° C. is in turn crucial for avoiding the incorporation of foreign bodies into the olivine.

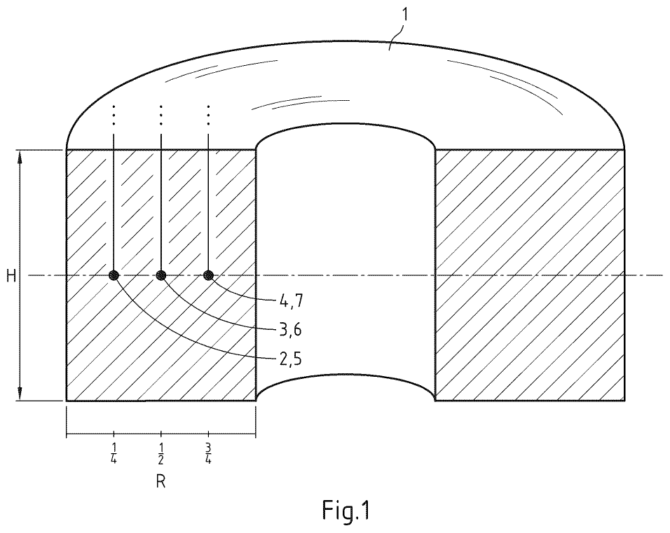

Since the temperature in the coil is not homogeneously distributed during step f), thermocouples are preferably installed distributed across the coil, as shown in FIG. 1. Dew point measuring devices are also installed at the same location in the coil.

The dew points dp1 and dp2 can be determined individually by each of these dew point measuring devices by extracting the gas from the windings with pipes of different defined diameters (6, 4, 2 and 1 mm) at 400° C. and 800° C., respectively, and extrapolating these actually determined dew point measured values to the value 0 mm. For this purpose, the dew point measured values obtained for the defined pipe diameters at 400° C. or 800° C. are entered into a diagram depending on the defined pipe diameter. The y-axis of the diagram indicates the dew point in ° C. and the x-axis the diameter of the pipe in mm. The dew point measured values obtained for the defined pipe diameters at 6, 4, 2 and 1 mm and entered into the diagram are extrapolated to the intersection point with the y-axis. Through extrapolation, the dew point at a theoretical pipe diameter of 0 mm is obtained, which corresponds to the dew point dp1 or dp2 to be used in formula (I). To calculate the extrapolation for the theoretical pipe diameter of 0 mm, the dew points at the relevant pipe diameters 6, 4, 2 and 1 mm must first be entered into a standard data software, such as MS Excel, to determine the logarithmic trend line. The formula calculated in MS-Excel for the logarithmic trend line corresponds to the form y=a·ln(bx)+c. To calculate the dew point at 0 mm, the function must now be shifted, since the logarithm of 0 is undefined and therefore no realistic value for the dew point can be obtained. For this purpose, the formula given by MS Excel is modified such that the following is obtained: y=a·ln(bx+1)+c, i.e., the term bx in the brackets of the logarithm is supplemented by +1. The dew point at 0 mm therefore approximately corresponds to the c determined by the logarithmic trend line.

A significant difference between carrying out the bell annealing in step f) of the method according to the invention and the prior art is that the bell annealing process is usually controlled based on the bell temperature (see, for example, EP 2 963 130 B1). However, due to the large dimensions of a coil and the associated local differences in the coil with regard to temperature and dew point during bell annealing, precise and accurate regulation and control of the method is not possible. The determination of the dew points and the actual temperature at specific positions in the coil by means of thermocouples installed at these positions in the coil, as shown in FIG. 1, allows a more accurate and precise regulation and control of the method.

In step f) of the method according to the invention, a secondary recrystallization takes place with formation of a forsterite layer. The coil obtained in step e) can be heated rapidly in step f), for example, to a maximum soaking temperature of 1150° C. or more, with maximum soaking temperatures of at least 1200° C. being particularly advantageous. Heating and soaking preferably takes place under a protective gas atmosphere, which comprises, for example, H₂. Particularly preferably, the heating to and the soaking at the relevant soaking temperature is carried out under an atmosphere containing 5 to 100 vol. % H₂, preferably 50 to 100 vol. % H₂, the remainder being nitrogen or any inert gas or a mixture of nitrogen and one or more inert gases. The soaking time during which the bell annealing is carried out in this way can be determined in a conventional manner well known to a person skilled in the art. Soaking times between 10 and 200 hours are common. Soaking times of at least 10 hours ensure that atoms of elements such as S and N are sufficiently removed, the retention of which would otherwise deteriorate the properties of the grain-oriented electrical steel sheet. A duration of more than 200 hours would be uneconomical, as it would lead to a reduction in the olivine formed in the previous heating phase of the bell annealing and the proportion of silicon dioxide formed would increase. This would have a negative impact on the formation of the forsterite layer (the glass layer). The bell annealing in step f) of the method according to the invention can, for example, be carried out for at least 10 h at a maximum soaking temperature of up to 1247° C. under an atmosphere of at least 50% H₂.

Preferably, the bell annealing in step f) of the method according to the invention is carried out for an annealing time of 10-200 h in a 100% H₂ atmosphere. During heating to maximum temperature, one or more holding stages can be incorporated to equalize the temperature in the coil and avoid temperature gradients. Typical average heating rates to maximum temperature are between 5 K/h and 50 K/h. Heating rates below 5 K/h prove to be negative in terms of productivity and, in addition, the grains can become too large even before secondary recrystallization, thus reducing the driving forces for secondary recrystallization. Average heating rates above 50 K/h can lead to inhomogeneous temperature distribution in the coil and thus to inhomogeneous product properties.

The cooling after the bell annealing in step f) of the method according to the invention can also take place in a controlled manner. Average cooling rates of less than 50 K/h have proven to be advantageous. Cooling can take place with or without a bell in a controlled atmosphere or ambient atmosphere. Average cooling rates above 50 K/h can lead to stresses in the material and thus to poorer processability in subsequent processes and to increased core losses.

In accordance with a preferred embodiment of the method according to the invention, the steel strip is cleaned and optionally pickled after step f) and before step g). The methods used to pickle the steel strip are known to a person skilled in the art. For pickling, the steel strip can be treated with an aqueous acidic solution. Appropriate acids include phosphoric acid, sulfuric acid and/or hydrochloric acid.

In step g) of the method according to the invention, an insulation coating is applied to the flat steel product annealed in step f) and optionally subsequently cleaned and optionally pickled. The insulation coating is preferably applied to at least one side of the flat steel product. The method for applying the insulation coating is known to a person skilled in the art and can be found, for example, in EP 2 902 509 B1 and EP2 954 095 Al. To form the insulation coating, an aqueous solution comprising colloidal silica (colloidal silicon dioxide), as well as at least one phosphate, nitrate and/or oxide containing at least one element selected from Al, Mn, Si, Ti, Mg, Sn and Cr is preferably applied to the surface of the steel sheet. In accordance with a preferred embodiment of the method according to the invention, the insulation coating is applied on both sides of the flat steel product. It is particularly preferred that the application weight of the insulation coating be the same on both sides. It goes without saying that the same application weight, as previously described, means that the application weight of the insulation coating is the same within the scope of unavoidable deviations due to production technology.

In step h) of the method according to the invention, a stress relieving of the flat steel product provided with the insulation coating is carried out to form the insulation layer. This can be done at temperatures in the range of 800° C. to 950° C. for 10 to 600 s. At the same time, the insulation coating applied in step g) is fired to form the insulation layer. An insulation layer applied to a grain-oriented flat steel product has a positive effect on minimizing hysteresis losses. The insulation layer can transfer tensile stresses to the base material, which not only improves the magnetic loss values of the grain-oriented flat steel product, but also reduces magnetostriction and has a positive effect on the noise behavior of the finished transformer. The insulation layer is completely permeable to the laser used in step i), i.e., it has a transmittance of 100%.

In accordance with step i) of the method according to the invention, domain refinement is carried out on at least one side of the flat steel product provided with the insulation layer by means of a laser with a wavelength WL, wherein the wavelength WL of the laser satisfies the specification of the following formula (I):

$$537 + \frac{( 60 \times dp 1 + 10 \times dp 2 )}{w 1} < WL < 1080 + \frac{18 \times dp 1 + 3 \times dp 2}{w 1} . \qquad ( I )$$

The selection of a laser with a wavelength WL that satisfies the above-mentioned formula (I) for the domain refinement in accordance with step i) of the method according to the invention results in the laser wavelength being adapted to the transmittance of the forsterite layer obtained in step f) such that a grain-oriented flat steel product according to the invention with optimized magnetostrictive properties and at the same time minimized core losses can be reliably obtained.

The method for domain refinement by laser beam treatment is known to a person skilled in the art and can be found, for example, in EP 2 675 927 A1. For example, during laser treatment, linear deformations arranged at a distance into the surface of the flat steel product are formed by means of a laser beam emitted from a laser beam source, thereby reducing the width of the domains and reducing the losses of the grain-oriented electrical steel sheet. Preferably, the domain refinement in step i) is carried out transversely to the rolling direction and at predefined intervals in the rolling direction.

A further subject matter of the invention is a grain-oriented flat steel product, comprising a steel core having the following composition, in wt. %:
Si: 2.0-4.0%,
C: <30 ppm,
Alₛᵢ: <30 ppm,
N: <50 ppm,
optionally one or more elements selected from the group consisting of Se, Sn, Sb, the individual contents of these elements being up to 0.2%,
optionally one or more elements selected from the group consisting of Cr, Cu, Mn, the individual contents of these elements being up to 0.60%,
optionally one or more elements selected from the group consisting of As, Bi, B, Co, Te, Ti, V, Ni, Nb, Mo, the individual contents of these elements being up to 0.05%,
optionally
S: <50 ppm
P 0.0003% to 0.05%
   remainder iron and unavoidable impurities,
   and a forsterite layer on at least one side of the steel core in full-surface contact therewith, wherein the side of the forsterite layer facing away from the steel core is in full-surface contact with an insulation layer, wherein at least one side of the grain-oriented flat steel product has been treated with a laser for domain refinement, characterized in that the difference in magnetostriction, measured according to IEC 60404-17 (2021) with a mirror, between one side of the grain-oriented flat steel product and the other side of the grain-oriented flat steel product is less than 1 dB(A), and wherein the grain-oriented steel flat product has a core loss, measured according to IEC 60404-3 (2022) at 50 Hz and 1.7 T and a conversion factor of 0.925 according to IEC 60404-8-7 (2020), of at most 0.75 W/kg.

In accordance with a particularly preferred embodiment of the grain-oriented flat steel product according to the invention, the steel core has the following composition in wt. %:
Si: 2.0-4.0%,
C: <30 ppm,
Alₛᵢ: <30 ppm,
N: <50 ppm
Mn: 0.002 to 0.60%,
Cu: 0.002 to 0.60%,
optionally one or more elements selected from the group consisting of Se, Sn, Sb, the individual contents of these elements being up to 0.2%,
optionally up to 0.60% Cr,
optionally one or more elements selected from the group consisting of As, Bi, B, Co, Te, Ti, V, Ni, Nb, Mo, the individual contents of these elements being up to 0.05%, optionally
S: <50 ppm
P 0.0003% to 0.05%
remainder iron and unavoidable impurities.

The chemical composition of the steel core of the finished grain-oriented flat steel product differs from the chemical composition of the cold-rolled flat steel product used in the method according to the invention with regard to the contents of Alₛᵢ, C, N and S. For the other elements and the maximum content of unavoidable impurities, the above statements in connection with the cold-rolled flat steel product apply accordingly.

In grain-oriented flat steel products, the content of Alₛᵢ is lower than in cold-rolled flat steel product. Alₛᵢ is present in the cold-rolled flat steel product after nitriding mainly as AlN inhibitor particles. During high-temperature annealing, the particles dissolve, Al diffuses to the steel surface and combines with other elements to form mixed compounds, so-called spinels. These are not acid soluble, which is why the Alₛᵢ content in the steel core of the grain-oriented flat steel product is limited to 30 ppm.

Since the cold-rolled flat steel product is subjected to decarburization annealing to produce the grain-oriented flat steel product, the carbon content falls and its maximum content is limited to 30 ppm in the steel core of the grain-oriented flat steel product.

The maximum nitrogen content in the steel core of the grain-oriented flat steel product is limited to 50 ppm because, although the cold-rolled flat steel product may be subjected to nitriding to produce the grain-oriented flat steel product, it is subsequently also subjected to purification during bell annealing.

At the same time, the flat steel product is purified from sulfur during bell annealing so that the maximum sulfur content in the steel core of the grain-oriented flat steel product is 50 ppm.

Since the flat steel product is provided with a phosphate-containing insulation layer, the maximum phosphorus content in the grain-oriented flat steel product is higher than in the cold-rolled flat steel product used for production. In the steel core of the grain-oriented flat steel product, the P content does not change compared to the cold-rolled flat steel product used for production.

Domain refinement on both sides can lead to an increase in the average magnetostriction value and possibly also to an increase in the hysteresis loss and thus to an increase in the total core loss. Thus, preferably, only one of the two sides of the grain-oriented flat steel product is treated with a laser for domain refinement. The inventors have recognized that this results in a different magnetostriction between the treated side and the untreated side of the grain-oriented flat steel product, while in untreated grain-oriented flat steel products this is almost identical on both sides.

In the course of further investigations, it was surprisingly found that the difference in magnetostriction between the two sides of a grain-oriented flat steel product has a significant influence on the noise generation when the grain-oriented flat steel product is used in a transformer.

The magnetostriction difference is the absolute distance between the magnetostriction, measured according to IEC 60404-17 (2021) with a mirror, of one side of the grain-oriented flat steel product and the other side of the grain-oriented flat steel product. It goes without saying that this distance can be negative or positive depending on the direction of the deduction. However, in the sense of the invention, only the resulting amount as such is considered without the relevant sign. Therefore, if the determined difference in magnetostrictions between both sides of the grain-oriented flat steel product is “−2,” this is regarded as a difference in magnetostriction of “2” according to the invention. The same applies if the determined difference in magnetostrictions between both sides of the grain-oriented flat steel product is “+2.”

It was found that the noise generation can be positively influenced by keeping the difference in magnetostriction, measured according to IEC 60404-17 (2021) with a mirror, to less than 1 dB(A), i.e., as low as possible.

This can be done, for example, by producing the grain-oriented flat steel product by means of the method according to the invention. Alternatively, it is also possible to obtain the grain-oriented flat steel product according to the invention by using conventional manufacturing processes for grain-oriented flat steel products and adjusting the difference in magnetostriction, measured according to IEC 60404-17 (2021) with a mirror, to a value of less than 1 dB(A) by other appropriate measures.

In accordance with a preferred embodiment of the grain-oriented flat steel product according to the invention, it comprises a steel core, which has the composition given above, and a forsterite layer on both sides of the steel core in full-surface contact therewith, wherein the side of the relevant forsterite layer facing away from the steel core is in full-surface contact with an insulation layer in each case, wherein at least one side of the grain-oriented flat steel product has been treated with a laser for domain refinement, characterized in that the difference in magnetostriction, measured according to IEC 60404-17 (2021) with a mirror, between one side of the grain-oriented flat steel product and the other side of the grain-oriented flat steel product is less than 1 dB(A), and wherein the grain-oriented steel flat product has a core loss, measured according to IEC 60404-3 (2022) at 50 Hz and 1.7 T and a conversion factor of 0.925 according to IEC 60404-8-7 (2020), of at most 0.75 W/kg. Preferably, the thickness of the two insulation layers is almost identical, i.e., the difference in layer thickness of the two insulation layers on both sides of the grain-oriented steel flat product is at most 25%, preferably at most 15%.

In accordance with a preferred embodiment of the grain-oriented flat steel product according to the invention, the grain-oriented flat steel product has a change in core loss P_{L} for which the following applies:

$$\frac{{P}_{1} - {P}_{0}}{{P}_{0}} \cdot 100 \% = {P}_{L} \geq 7 \% ,$$

wherein P₀ is the core loss after laser treatment, P₁ is the core loss after annealing for 30 min, and P_{L} is the change in core loss due to laser treatment, all measured according to IEC 60404-8-7 (2020) at 50 Hz and 1.7 T

To determine the improvement in the core losses due to domain refinement by means of laser treatment, the core loss must be measured before and after laser treatment. This is not possible in a continuous furnace for carrying out the steps g) and h) with subsequent laser treatment for domain refinement (step i)), since the continuous process would have to be interrupted and the grain-oriented steel flat product cut up for this purpose. Furthermore, measurements of the magnetic hysteresis loss with a closed yoke, as required by IEC-60404-2 and -3, cannot be carried out on a continuous furnace. For this reason, the improvement in the magnetic hysteresis losses due to the laser treatment is determined by cutting the grain-oriented steel flat product into samples of 610 mm×100 mm after step i) of the invention-based process and subjecting them to an annealing treatment. In this process, the samples are annealed for 30 min at 850° C. and 100% N-containing atmosphere and then cooled at about 30 K/h. Since the improvements in the magnetic hysteresis loss caused by the laser treatment are not thermally stable, an improvement in the magnetic hysteresis losses caused by the laser treatment is canceled out by the annealing treatment.

By determining the difference in the core losses before and after the annealing treatment, the change in the core losses P_{L} can be determined using the formula given above, which represents a measure of the improvement in the core losses achieved by the laser treatment. An advantage of this method is that it allows a comparison with other grain-oriented domain-refined steel flat products.

According to a further preferred embodiment of the grain-oriented steel flat product according to the invention, in its surface profile across the area of the laser treatment, i.e. in the rolling direction, over a measuring distance of 2000 μm, on average no recesses are present which are deeper than 0.8 μm, preferably deeper than 0.3 μm. Such indentations deeper than 0.8 μm are usually found on state-of-the-art grain-oriented steel flat products. The measurement of the depressions in the surface profile is carried out with a 3D laser scanning microscope from Keyence, type VK-X3000, across the area of the laser treatment, i.e. in the rolling direction, over a measuring range of 2000 μm. The difference between the mean height of the non-laser-treated, i.e. non-domain-refined, area of the sample surface and the mean height of the domain-refined area of the sample surface gives the height of the depression produced by the laser.

Finally, the grain-oriented steel flat product according to the invention is also preferably characterized in that the insulation effect of the insulation layer system is retained by the laser treatment described, i.e. an insulation effect of at least 50 Ωcm² measured according to IEC 60404-11 (2021), is achieved in the laser treatment area.

FIG. 1 shows schematically how the thermocouples 2, 3, 4 for measuring the temperature and the dew point measuring devices 5, 6 and 7 for determining the dew points dp1 and dp2 in step f) of the method according to the invention may be installed in the coil 1. The temperature is measured, for example, by means of thermocouples 2, 3, 4, which are mounted centrally above coil height H and at three locations across the coil radius R, evenly distributed at ¼, see thermocouple 2, ½, see thermocouple 3, and ¾, see thermocouple 4, of the coil height H. As soon as the temperature at the relevant thermocouple 2, 3, 4 reaches the value 400° C. or 800° C., the dew points dp1 or dp2 are measured by suction through pipes with a defined diameter of 1, 2, 4 and 6 mm using the dew point measuring device 5, 6, 7, which is also installed at the same location. To determine the dew points dp1 or dp2 for the formula (I), it is sufficient if the measurement is carried out on a thermocouple 2, 3 or 4 using the dew point measuring device 5, 6 or 7 installed at the same location at 400° C. or 800° C. respectively. The installation of several thermocouples and dew point measuring devices, as shown in FIG. 1, serves, in particular, to allow for the bell annealing process to be regulated and controlled more accurately and precisely. For example, holding times at certain temperatures during bell annealing can be adjusted to ensure that the target temperature is also reliably reached inside the coil 1 for a certain duration.

To demonstrate the effect of the invention, the following examples have been investigated.

### Example 1

A cold-rolled flat steel product with a thickness of 0.22 mm was provided, having the following composition, in wt. %: 3.3% Si, 0.075% C, 0.12% Mn, 0.05% Alₛᵢ, 0.009% N, 0.1% Cu, 0.011% S, 0.03% P, remainder iron and unavoidable impurities. The cold-rolled flat steel product was subjected to primary recrystallization annealing with simultaneous decarburization treatment at 850° C. under an atmosphere of 75% H₂ and 25% N₂ with a dew point of 60° C. for 110 s. Immediately afterwards, a nitriding treatment was carried out under an atmosphere with a dew point of approx. 5° C. and addition of NH₃ to the atmosphere with 75% H₂ and 25% N₂, up to a nitriding level of 160 ppm. Both sides of the flat steel product were then coated with a slurry of 95 wt. % MgO and 5% TiO₂, based on the total solids content of the slurry, and a mass ratio of water to total solids in the slurry of 8 and reeled into a coil with a reel tension of 80 MPa.

The material was then annealed in a bell furnace at 1200° C. for 24 hours. The dew points when heated to 1200° C. were determined at 400° C. and 800° C. using the procedure given above in the description of step f) of the method according to the invention and in connection with FIG. 1 and are given in Table 1. After cooling to room temperature, the coil was uncoiled and the annealing residues, e.g., non-adhering forsterite and other products, were removed with a smooth brush and water, and an insulation coating of aluminum phosphate, colloidal silicon dioxide and chromic acid was applied to both sides of the flat steel product. The insulation coating was stress-relieved at 860° C. and fired to form an insulation layer.

Subsequently, one-sided domain refinement was carried out using a laser having a wavelength WL stated in Table 1.

The carbon content of the steel core of the grain-oriented flat steel product was less than 0.003 weight percent. Due to spinel formation at the interface between forsterite and steel core, the Alₛᵢ content in the steel core of the grain-oriented flat steel product falls below 30 ppm. As a result of the purification annealing, the nitrogen and sulfur contents in the steel core of the grain-oriented flat steel product have fallen to below 10 ppm.

### Example 2

A cold-rolled flat steel product with a thickness of 0.22 mm was provided, having the following composition, in wt. %: 3.3% Si, 0.085% C, 0.08% Mn, 0.03% Alₛᵢ, 0.009% N, 0.1% Cu, 0.02% S, 0.01% P, remainder iron and unavoidable impurities. The cold-rolled flat steel product was subjected to primary recrystallization annealing with simultaneous decarburization treatment at 850° C. under an atmosphere with 75% H₂ and 25% N₂ with a dew point of 60° C. for 150 s. The flat steel product was then coated on both sides with a slurry of 95% MgO and 5% TiO₂, based on the total solids content of the slurry and a mass ratio of water to total solids in the slurry of 8 and reeled into a coil with a reel tension of 80 MPa.

The coil was then annealed in a bell furnace at 1200° C. for 24 hours. The dew points when heated to 1200° C. were determined at 400° C. and 800° C. using the procedure given above in the description of step f) of the method according to the invention and in connection with FIG. 1 and are given in Table 1.

After cooling to room temperature, the coil was uncoiled and the annealing residues, e.g., non-adhering forsterite and other products, were removed with a smooth brush and water, and an insulation coating of aluminum phosphate, colloidal silicon dioxide and chromic acid was applied to both sides of the flat steel product. The insulation coating was stress-relieved at 860° C. and fired to form an insulation layer.

Subsequently, one-sided domain refinement was carried out using a laser having a wavelength WL stated in Table 1.

The carbon content of the steel core of the grain-oriented flat steel product was less than 0.003 weight percent. Due to spinel formation at the interface between forsterite and steel core, the Alₛᵢ content in the steel core of the grain-oriented flat steel product falls below 30 ppm. As a result of the purification annealing, the nitrogen and sulfur contents in the steel core of the grain-oriented flat steel product have fallen to below 10 ppm. By adjusting the wavelength of the laser WL according to the invention depending on the water to solid ratio in the slurry as well as on the dew points at 400° C. and 800° C. when heating to the soaking temperature during bell annealing, a difference in magnetostriction, measured according to IEC 60404-17 (2021) with a mirror, between one side of the grain-oriented flat steel product and the other side of the grain-oriented flat steel product can be adjusted to less than 1 dB(A), while at the same time minimizing the core losses.

After the magnetostriction measurement was carried out, the samples were measured in the area of the laser treatment according to IEC 60404-11 (2021) and the determined resistivity value in Ωcm² was entered in Table 2. For non-visible domain-refined areas, the area is to be determined using a commercially available domain viewer such as the DV 90 from Brockhaus.

To examine the morphology of the domain-refined areas, a Keyence VK-X3000 3D laser scanning microscope was used. A surface profile was generated across the domain-refined area. The difference between the height of the sample surface and the mean height of the domain-refined area gives the height of the depression created by the laser. The depressions determined in this way were entered in Table 2.

The improvement in the core loss was determined by annealing the samples for 30 min at 850° C. in a 100% N-containing atmosphere and then cooling them at about 30 K/h. Since the laser treatment is thermally unstable, the improvement in the core losses is now eliminated. By determining the change in the core losses before and after annealing, the improvement in core losses due to laser treatment can be determined.

The calculation is carried out as follows:

$$\frac{{P}_{1} - {P}_{0}}{{P}_{0}} \cdot 100 \% = {P}_{L} .$$

The measurement of the core losses took place according to IEC 60404-8-7 (2020), with a conversion factor of 0.925 each. The results of the respective differences in core losses before and after the annealing treatment P_{L} were entered in Table 2.

To determine the thickness of the outer insulation layers on both sides of the grain-oriented steel flat product, the samples must first be weighed. To remove the phosphate layer on one side, the sample side whose insulation layer is not to be removed must be taped with acid-resistant adhesive tape. To remove the insulation layer on the non-taped side of the sample, place the sample in 25% NaOH at 60° C. for 20 minutes. Then rinse the sample first with water and then with ethanol and dry. Remove the adhesive tape from the sample and then remove any adhesive residue from the sample with Ascusol. Then weigh the sample again. The layer thickness in g/m² on the unsealed side is to be determined from the difference in weight. To determine the layer thickness on the other side, the procedure is to be carried out in reverse. The layer thicknesses determined were compiled in Table 2.

TABLE 1

| | | | | | | | | | | | | | Production | |
|---|---|---|---|---|---|---|---|---|---|---|---|---|---|---|
| | | | | | | | | | | | | | path in | |
| | | | | | | LvA | | | | | | | accordance | |
| | | | | | | Diff | | | | | | | with | |
| | Measured | Ps | λ z-p | λ p-p | LvA | (A − B) | WL1 | WL2 | WL | dp1 | dp2 | | example | Inventive? |
| No. | side | [W/kg] | [μm/m] | [μm/m] | [dB(A)] | [dB(A)] | [nm] | [nm] | [nm] | [° C.] | [° C.] | w1 | 1 or 2? | YES/NO |
| 1 | A | 0.707 | −0.1 | 0.4 | 87.3 | −2.5 | 569 | 1128 | 1152.3 | 16 | 15 | 8.0 | 1 | NO |
| 2 | B | 0.710 | −1.0 | 1.0 | 89.7 | | | | | | | | | |
| 3 | A | 0.754 | −0.5 | 0.5 | 87.7 | −2.2 | 565 | 1108 | 1152.3 | 10 | −7 | 3.1 | 1 | NO |
| 4 | B | 0.746 | −1.1 | 1.1 | 89.9 | | | | | | | | | |
| 5 | A | 0.736 | −0.5 | 0.5 | 87.5 | −2.4 | 584 | 1143 | 1200 | 24 | 5 | 5.5 | 2 | NO |
| 6 | B | 0.736 | −1.1 | 1.1 | 90.0 | | | | | | | | | |
| 7 | A | 0.736 | −0.6 | 0.6 | 87.5 | −2.1 | 708 | 1313 | 694.3 | 41 | 15 | 12.0 | 2 | NO |
| 8 | B | 0.724 | −1.0 | 1.0 | 89.6 | | | | | | | | | |
| 9 | A | 0.725 | −0.3 | 0.4 | 87.2 | −3.4 | 559 | 1105 | 1152.3 | 10 | −3 | 3.2 | 1 | NO |
| 10 | B | 0.721 | −1.1 | 1.1 | 90.5 | | | | | | | | | |
| 11 | A | 0.743 | −0.2 | 0.3 | 85.8 | −7.3 | 800 | 1460 | 694.3 | 44 | 30 | 11.3 | 1 | NO |
| 12 | B | 0.739 | −1.3 | 1.7 | 93.1 | | | | | | | | | |
| 13 | A | 0.738 | −0.4 | 0.5 | 87.2 | −4.3 | 535 | 1050 | 1062 | 13 | −17 | 2.3 | 1 | NO |
| 14 | B | 0.742 | −1.2 | 1.3 | 91.5 | | | | | | | | | |
| 15 | A | 0.731 | 0.3 | 0.8 | 88.9 | −4.7 | 50 | 1024 | 1062 | −10 | −15 | 5.6 | 1 | NO |
| 16 | B | 0.730 | −1.6 | 1.7 | 93.6 | | | | | | | | | |
| 17 | A | 0.723 | 0.2 | 0.6 | 88.6 | −2.8 | 586 | 1153 | 1200 | 13 | 11 | 4.1 | 2 | NO |
| 18 | B | 0.725 | −1.3 | 1.3 | 91.5 | | | | | | | | | |
| 19 | A | 0.724 | −0.5 | 0.5 | 88.0 | −3.6 | 572 | 1128 | 1152.3 | 17 | 5 | 5.5 | 2 | NO |
| 20 | B | 0.716 | −1.3 | 1.3 | 91.6 | | | | | | | | | |
| 21 | A | 0.852 | −0.4 | 0.4 | 86.0 | −5.4 | 599 | 1172 | 1200 | 22 | 20 | 9.7 | 2 | NO |
| 22 | B | 0.845 | −1.2 | 1.3 | 91.4 | | | | | | | | | |
| 23 | A | 0.719 | −0.5 | 0.6 | 87.5 | −0.6 | 634 | 1217 | 1152.3 | 36 | 19 | 8.9 | 1 | YES |
| 24 | B | 0.718 | −0.6 | 0.7 | 88.1 | | | | | | | | | |
| 25 | A | 0.698 | −0.2 | 0.4 | 89.3 | −0.7 | 681 | 1250 | 1200 | 45 | −8 | 5.3 | 1 | YES |
| 26 | B | 0.700 | −0.7 | 0.9 | 89.9 | | | | | | | | | |
| 27 | A | 0.719 | −0.4 | 0.6 | 88.9 | −0.9 | 608 | 1179 | 1062 | 28 | 11 | 6.1 | 1 | YES |
| 28 | B | 0.711 | −0.9 | 1.0 | 89.8 | | | | | | | | | |
| 29 | A | 0.717 | −0.8 | 0.9 | 90.7 | −0.4 | 657 | 1254 | 694.3 | 16 | 9 | 7.2 | 2 | YES |
| 30 | B | 0.716 | −1.1 | 1.1 | 91.2 | | | | | | | | | |
| 31 | A | 0.712 | −0.5 | 0.5 | 89.2 | −0.5 | 598 | 1165 | 1030 | 25 | 12 | 9.3 | 2 | YES |
| 32 | B | 0.709 | −0.9 | 1.0 | 89.6 | | | | | | | | | |

Ps: specific core loss, Ss: specific apparent power, λ z-p [μm/m]: zero to peak value of magnetostriction, λ p-p [μm/m]: peak to peak value of magnetostriction, LvA [dB(A)]: A-weighted velocity level of magnetostriction, LvA Diff (A − B) [dB(A)]: difference of the A-weighted velocity levels of magnetostriction measured on A and B side of the testing sample, all parameters named in the legend of Table 1 were determined at 1.7 T and 50 Hz. λ z-p, λ p-p and LvA were measured according to IEC 60404-17 (2021) and Ps according to IEC 60404−3 (2022).

TABLE 2

| | | | | | | Insulation |
|---|---|---|---|---|---|---|
| | Layer | Layer | | | Depth of the | effect of the |
| | thickness | thickness | Difference layer | | domain- | domain- |
| | side A | side B | thickness A to B | P_{L} | refined area | refined area |
| No. | [g/m²] | [g/m²] | ([(A − B)/A] · 100%) | [%] | [μm] | [Ωcm²] |
| 1-2 | 3.6 | 3.1 | 14% | 6.0 | 0.66 | >50 |
| 3-4 | 4.7 | 4.0 | 15% | 9.3 | 0.87 | <50 |
| 5-6 | 4.9 | 3.6 | 27% | 8.8 | 0.93 | >50 |
| 7-8 | 4.3 | 3.4 | 21% | 3.4 | 1.24 | <50 |
| 9-10 | 4.0 | 3.3 | 18% | 4.8 | 1.04 | <50 |
| 11-12 | 4.2 | 3.6 | 14% | 6.3 | 1.87 | <50 |
| 13-14 | 4.6 | 3.4 | 26% | 7.4 | 1.18 | <50 |
| 15-16 | 4.9 | 5.5 | 12% | 4.4 | 1.01 | <50 |
| 17-18 | 3.7 | 3.5 | 5% | 4.8 | 0.40 | >50 |
| 19-20 | 5.0 | 4.3 | 14% | 8.6 | 1.63 | <50 |
| 21-22 | 4.6 | 4.3 | 7% | 6.8 | 0.35 | >50 |
| 23-24 | 4.3 | 3.7 | 14% | 8.0 | 0.16 | >50 |
| 25-26 | 3.5 | 4.0 | 14% | 9.0 | 0.22 | >50 |
| 27-28 | 3.9 | 4.4 | 13% | 9.1 | 0.03 | >50 |
| 29-30 | 4.4 | 4.7 | 7% | 10.5 | 0.16 | >50 |
| 31-32 | 4.3 | 4.6 | 7% | 7.2 | 0.06 | >50 |

Layer thickness side A of the outermost insulation layer on side A in g/m². Layer thickness side B of the outermost insulation layer on side B in g/m². Difference layer thickness A to B determined according to: ([(A − B)/A] · 100%). P_{L}: Difference between P₁ and P₀ determined according to the description in %, determined at 1.7 T and 50 Hz with a conversion factor of 0.925 according to IEC 60404-8-7 (2022). Depth of the domain refined area in μm measured using a 3D laser scanning microscope from Keyence, type VK-X3000. Insulation effect of the domain-refined area measured according to IEC 60404-11 (2021) in Ωcm².

1) A method for producing a grain-oriented flat steel product, comprising the work steps of:
a) providing a cold-rolled flat steel product having the following composition, in wt. %:
Si: 2.0-4.0%,
C: 0.01-0.10%,
Al—acid soluble: 0.01-0.065%,
N: 0.003-0.015,
optionally one or more elements selected from the group consisting of Se, Sn, and Sb, the individual contents of these elements being up to 0.2%,
optionally one or more elements selected from the group consisting of Cr, Cu, and Mn, the individual contents of these elements being up to 0.60%,
optionally one or more elements selected from the group consisting of As, Bi, B, Co, P, S, Te, Ti, V, Ni, Nb, and Mo, the individual contents of these elements being up to 0.05%, and
remainder iron and unavoidable impurities,
b) primary recrystallization annealing the cold-rolled flat steel product with simultaneous decarburization treatment in a humid atmosphere to a carbon content of less than 30 ppm,
c) optionally carrying out a nitriding treatment during step b) or subsequently in step c),
d) coating the flat steel product obtained in step b) or in the optional step c) with a slurry, wherein the slurry consists of water, MgO and optionally one or more further solid(s),
e) reeling the coated flat steel product to form a coil,
f) bell annealing the coil at a soaking temperature of at least 1100° C.,
g) applying an insulation coating to the annealed flat steel product,
h) stress relieving the flat steel product provided with the insulation coating forming an insulation layer, and
i) carrying out domain refinement using a laser having a wavelength WL on at least one side of the flat steel product provided with the insulation layer, wherein the wavelength WL of the laser satisfies the following formula:
$$537 + \frac{( 60 \times dp 1 + 10 \times dp 2 )}{w 1} < WL < 1080 + \frac{18 \times dp 1 + 3 \times dp 2}{w 1}$$
where w1 is a mass ratio of water to the total solids in the slurry of step d), dp1 is a dew point measured between turns of the coil at 400° C. during heating to the soaking temperature in step f), and dp 2 is a dew point measured between the turns of the coil at 800° C. during heating to the soaking temperature in step f).

2. The method according to claim 1, wherein the composition of the cold-rolled flat steel product provided in step a) contains 0.002 to 0.60 wt. % manganese.

3. The method according to claim 1, wherein the composition of the cold-rolled flat steel product provided in step a) contains 0.002 to 0.60 wt. % Cu.

4. The method according to claim 1, wherein the composition of the cold-rolled flat steel product provided in step a) contains 0.0003 to 0.05 wt. % P.

5. The method according to claim 1, wherein step b) is carried out at a dew point of 40 to 80° C.

6. The method according to claim 1, wherein step b) is carried out with an annealing time of more than 100 s and at a temperature of at least 820° C.

7. The method according to claim 1, wherein the flat steel product is nitrided during step b) or thereafter in step c) and the nitrogen content after step c) is at least 150 ppm.

8. The method according to claim 1, wherein the further solids in the slurry in accordance with step d) are, in addition to MgO, one or more oxides and/or nitrides of at least one element selected from the group consisting of Al, Cr, Fe, Mn, Si, Ti, Mg, Sn, and Zr, and mixed oxides of said oxides with Mg.

9. The method according to claim 1, wherein the reel tension in step e) is 30-300 MPa.

10. The method according to claim 1, wherein the bell annealing in step f) is carried out for an annealing time of at least 10 hours in a 100% H₂ atmosphere.

11. The method according to claim 1, wherein the insulation coating comprises colloidal silicon dioxide, as well as at least one phosphate, nitrate and/or oxide containing at least one element selected from Al, Mn, Si, Ti, Mg, Sn and Cr.

12. A grain-oriented flat steel product, comprising a steel core having the following composition, in wt. %:
Si: 2.0-4.0%,
C: <30 ppm,
Al—acid soluble: <30 ppm,
N: <50 ppm,
optionally one or more elements selected from the group consisting of Se, Sn, and Sb, the individual contents of these elements being up to 0.2%,
optionally one or more elements selected from the group consisting of Cr, Cu, and Mn, the individual contents of these elements being up to 0.60%,
optionally one or more elements selected from the group consisting of As, Bi, B, Co, Te, Ti, V, Ni, Nb, and Mo, the individual contents of these elements being up to 0.05%,
optionally S: <50 ppm and/or P 0.0003% to 0.05%, and
remainder iron and unavoidable impurities; and
a forsterite layer on at least one side of the steel core in full-surface contact therewith, wherein a side of the forsterite layer facing away from the steel core is in full-surface contact with an insulation layer, wherein at least one side of the grain-oriented flat steel product has been treated with a laser for domain refinement,
wherein the difference in magnetostriction, measured according to IEC 60404-17 (2021) with a mirror, between one side of the grain-oriented flat steel product and the other side of the grain-oriented flat steel product is less than 1 dB(A), and
wherein the grain-oriented steel flat product has a core loss, measured according to IEC 60404-3 (2022) at 50 Hz and 1.7 T and a conversion factor of 0.925 according to IEC 60404-8-7 (2020), of at most 0.75 W/kg.

13. The grain-oriented steel flat product according to claim 12, wherein the grain-oriented steel flat product has a change in the core loss P_{L}, for which the following applies:
$$\frac{{P}_{1} - {P}_{0}}{{P}_{0}} \cdot 100 \% = {P}_{L} \geq 7 \% ,$$
wherein P₀ is the core loss after laser treatment, P₁ is the core loss after annealing treatment for 30 min at 850° C. and P_{L} represents the change in core loss due to laser treatment, all measured according to IEC 60404-8-7 (2020) at 50 Hz and 1.7 T.

14. The grain-oriented steel flat product according to claim 12, wherein the at least one side of the grain-oriented steel flat product that has been treated with the laser for domain refinement has no pits along areas that are deeper than 0.8 μm and the locally measured resistance of the insulation layers according to IEC 60404-11 (2021) in the areas treated with the laser is at least 50 Ωcm².

15. The grain-oriented steel flat product according to claim 12, wherein a difference in layer thicknesses of the insulating layers of the two sides of the grain-oriented steel flat product is at most 25%.

16. The method according to claim 1, wherein the composition of the cold-rolled flat steel product provided in step a) contains 0.05 to 0.3 wt. % manganese.

17. The method according to claim 1, wherein the composition of the cold-rolled flat steel product provided in step a) contains 0.05 to 0.30 wt % Cu.

18. The method according to claim 1, wherein the composition of the cold-rolled flat steel product provided in step a) contains 0.005 to 0.045 wt. % P.
